(19) United States
(12) Patent Application Publication
(10) Pub. No.: US 2017/0014982 A1
(43) Pub. Date: Jan. 19, 2017

(54) Hinge Pin Removal Assembly

(71) Applicant: Norman Rieschi, Bolton (CA)

(72) Inventor: Norman Rieschi, Bolton (CA)

(21) Appl. No.: 14/801,943

(22) Filed: Jul. 17, 2015

(51) Int. Cl. B25B 27/04; E05D 11/00

(52) U.S. Cl. CPC B25B 27/04; E05D 11/00; E05Y 2900/132

(57) ABSTRACT

A hinge pin removal assembly for removing a pin from a hinge includes a handle. A member is coupled to the handle wherein the member may be positioned to abut a pin in a hinge. The handle may be struck when the member is positioned to abut the pin thereby facilitating the pin to be urged upwardly in the hinge. A grip is positioned around the handle wherein the grip may enhance a grip of the handle.

### BACKGROUND OF THE DISCLOSURE

### Field of the Disclosure

The disclosure relates to removal devices and more particularly pertains to a new removal device for removing a pin from a hinge.

### SUMMARY OF THE DISCLOSURE

An embodiment of the disclosure meets the needs presented above by generally comprising a handle. A member is coupled to the handle wherein the member may be positioned to abut a pin in a hinge. The handle may be struck when the member is positioned to abut the pin thereby facilitating the pin to be urged upwardly in the hinge. A grip is positioned around the handle wherein the grip may enhance a grip of the handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a hinge pin removal assembly according to an embodiment of the disclosure.

FIG. 2 is a top view of an embodiment of the disclosure.

FIG. 3 is a right side view of an embodiment of the disclosure.

FIG. 4 is a perspective in-use view of an embodiment of the disclosure.

FIG. 5 is a side perspective in-use view of an embodiment of the disclosure.

### DESCRIPTION OF THE PREFERRED EMBODIMENT

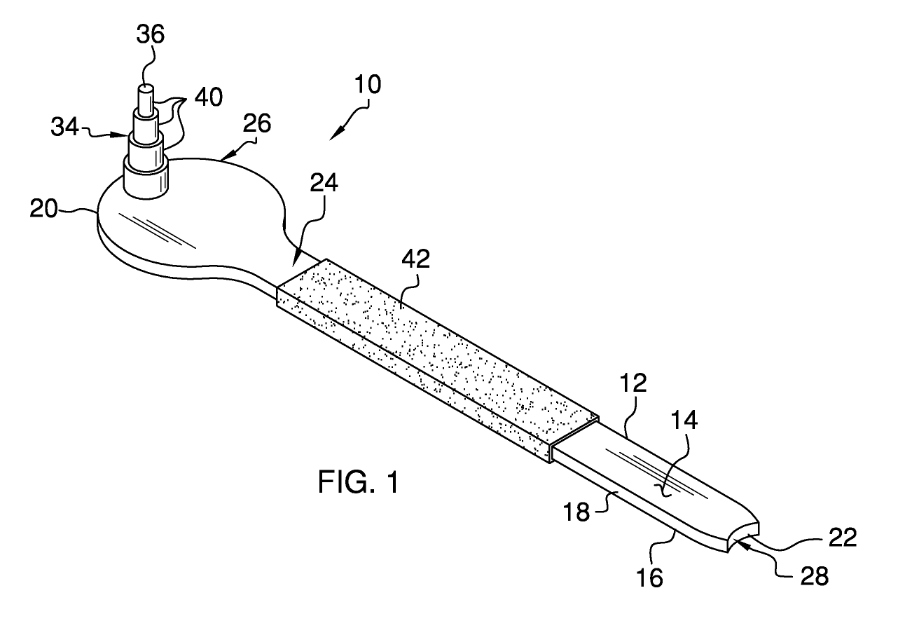

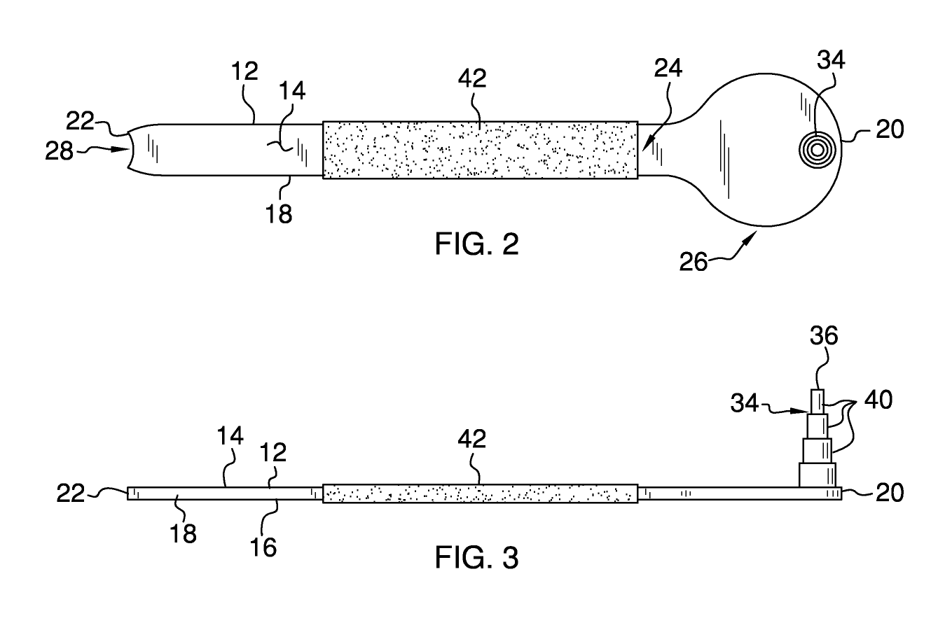

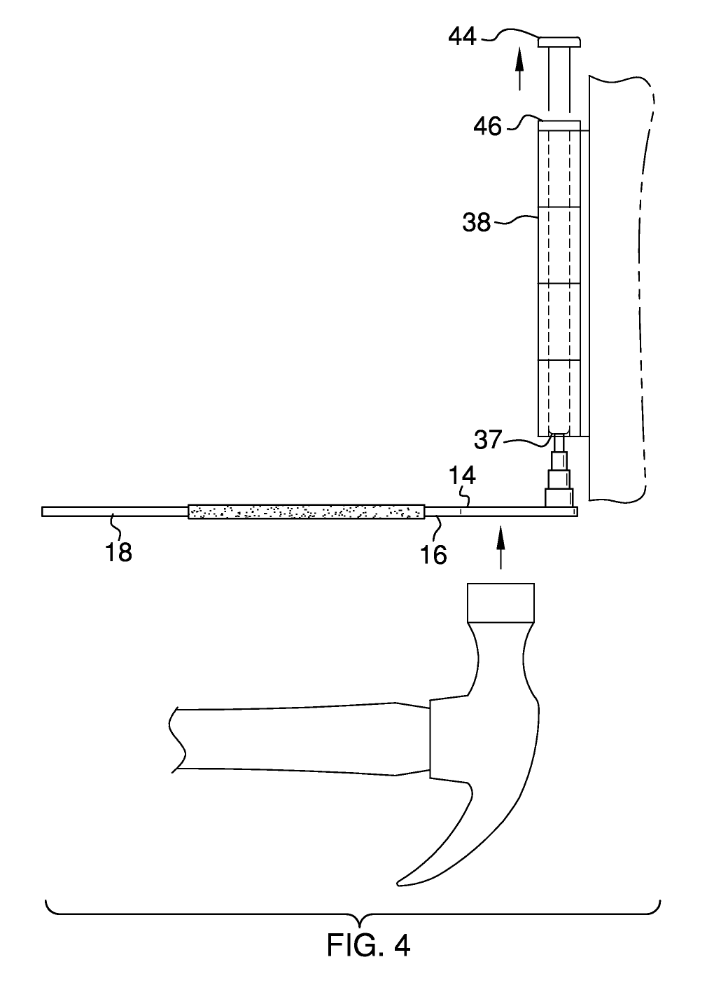

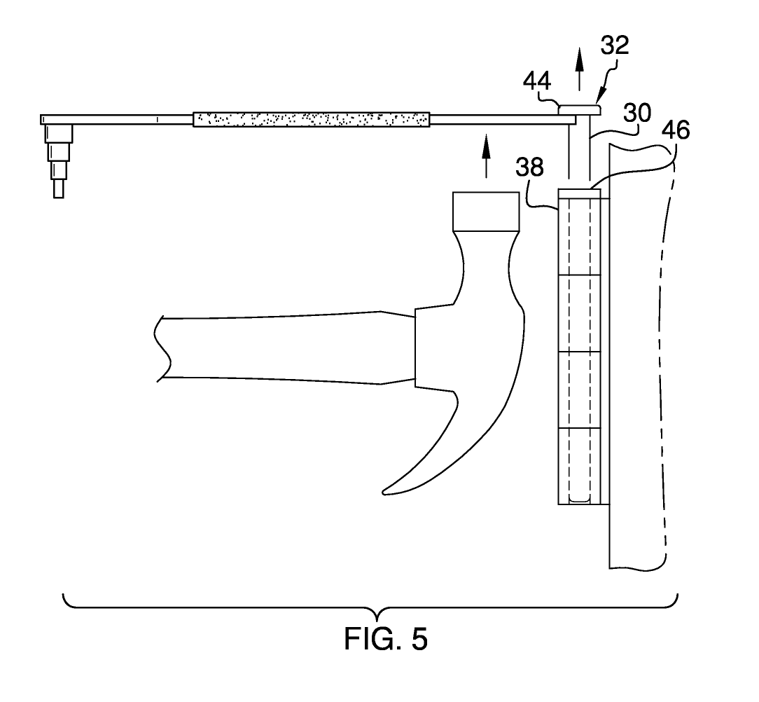

With reference now to the drawings, and in particular to FIGS. 1 through 5 thereof, a new removal device embodying the principles and concepts of an embodiment of the disclosure and generally designated by the reference numeral 10 will be described.

As best illustrated in FIGS. 1 through 5, the hinge pin removal assembly 10 generally comprises a handle 12 that has a top surface 14, a bottom surface 16 and a peripheral edge 18 extending between the top surface 14 and the bottom surface 16. The peripheral edge 18 has a front side 20 and a back side 22 and the handle 12 is elongated between the front side 20 and the back side 22. The handle 12 may have a length ranging between approximately 6 inches and 8 inches and the handle 12 may have a width ranging between approximately 2 inches and 3 inches. Additionally, the handle 12 may be comprised of a rigid material such that the handle 12 is capable of being struck without deforming the handle 12.

The peripheral edge 18 curves outwardly from a center 24 of the handle 12 adjacent to the front side 20 to define a round portion 26 of the handle 12. The back side 22 curves inwardly toward the front side 20 to define a groove 28 in the handle 12. The groove 28 may receive a shaft 30 of a pin 32. The pin 32 may be a hinge pin of a door or the like and the groove 28 is substantially parabolic.

A member 34 is coupled to the handle 12 and the member 34 extends away from the top surface 14. The member 34 is positioned on the round portion 26 and the member 34 is positioned adjacent to the front side 20. The member 34 has a distal end 36 with respect to the top surface 14 and the distal end 36 may be positioned to abut a bottom end 37 of the pin 32 when the pin 32 is installed in a hinge 38. The hinge 38 may be a door hinge or the like.

The member 34 has a plurality of sections 40 and each of the sections 40 is cylindrical. Each of the sections 40 has a decreasing diameter with respect to each other between the top surface 14 of the handle 12 and the distal end 36 of the member 34. The bottom surface 16 may be struck when the member 34 is positioned to abut the pin 32 thereby facilitating the pin 32 to be urged upwardly in the hinge 38. A grip 42 is positioned around the handle 12 thereby enhancing a grip of the handle 12. The grip 42 is centrally positioned between the front side 20 and the back side 22.

In use, the distal end 36 of the member 34 is positioned to abut the bottom end 38 of the pin 21. The bottom surface 16 of the handle 12 is struck such that the pin 21 is urged upwardly in the hinge 38 thereby spacing a head 44 of the pin 32 from a top 46 of the hinge 38. The back side 22 of the handle 12 is positioned against the pin 32 such that the pin 32 is positioned within the groove 28. The handle 12 is positioned between the head 44 of the pin 32 and the top 46 of the hinge 38. The handle 12 is struck such that the pin 32 is urged out of the hinge 38 thereby facilitating the pin 32 to be removed from the hinge 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hinge pin removal assembly configured to remove a pin from a hinge, said assembly comprising:
a handle;
a member being coupled to said handle wherein said member is configured to be positioned to abut a pin in a hinge, said handle being configured to be struck when said member is positioned to abut the pin thereby facilitating the pin to be urged upwardly in the hinge, said member having a plurality of sections, each of said sections being cylindrical, said sections having a common central longitudinal axis, each of said sections having a decreasing diameter with respect to each other between a top surface of said handle and a distal end of said member; and
a grip being positioned around said handle wherein said grip is configured to enhance a grip of said handle.

2. The assembly according to claim 1, wherein said handle has a top surface, a bottom surface and a peripheral edge extending between said top surface and said bottom surface, said peripheral edge having a front side and a back side, said handle being elongated between said front side and said back side, said peripheral edge curving outwardly from a center of said handle adjacent to said front side to define a round portion of said handle.

3. The assembly according to claim 2, wherein said back side curves inwardly toward said front side to define a groove in said handle wherein said groove is configured to receive a shaft of a pin, said groove being substantially parabolic.

4. The assembly according to claim 1, wherein:
said handle has a round portion and a front side; and
said member extending away from said top surface, said member being positioned on said round portion, said member being positioned adjacent to said front side.

5. (canceled)

6. The assembly according to claim 1, wherein:
said handle has a front side and a back side; and
said grip being centrally positioned between said front side and said back side.

7. A hinge pin removal assembly configured to remove a pin from a hinge, said assembly comprising:
a handle having a top surface, a bottom surface and a peripheral edge extending between said top surface and said bottom surface, said peripheral edge having a front side and a back side, said handle being elongated between said front side and said back side, said peripheral edge curving outwardly from a center of said handle adjacent to said front side to define a round portion of said handle, said back side curving inwardly toward said front side to define a groove in said handle wherein said groove is configured to receive a shaft of a pin, said groove being substantially parabolic;
a member being coupled to said handle, said member extending away from said top surface, said member being positioned on said round portion, said member being positioned adjacent to said front side, said member having a distal end with respect to said top surface wherein said distal end is configured to be positioned to abut a pin in a hinge, said member having a plurality of sections, each of said sections being cylindrical, said sections having a common central longitudinal axis, each of said sections having a decreasing diameter with respect to each other between said top surface of said handle and said distal end of said member, said bottom surface being configured to be struck when said member is positioned to abut the pin thereby facilitating the pin to be urged upwardly in the hinge; and
a grip being positioned around said handle wherein said grip is configured to enhance a grip of said handle, said grip being centrally positioned between said front side and said back side.
